(19) United States
(12) Patent Application Publication
(10) Pub. No.: US 2002/0175039 A1
(43) Pub. Date: Nov. 28, 2002

(54) Escalator support structure

(76) Inventors: Richard N. Fargo, Palinville, CT (US); Matthew John Dunlavey, Ann Arbor, MI (US); Jennifer Melanie Bastiaan, Windsor (CA); Michaelpaul Costa, (US); Catalin H. Popa, (US)

Correspondence Address: David J. Gaskey, CARLSON, GASKEY & OLDS, P.C., Suite 350, 400 West Maple Road, Birmingham, MI, 48009, US

(21) Appl. No.: 09/853,339

(22) Filed: May 11, 2001

(51) Int. Cl. B65G 21/08; B65G 21/20; B66B 21/04

(52) U.S. Cl. 198/321; 198/336; 198/860.2

(57) ABSTRACT

A support structure for an escalator includes a bottom landing, a top landing, and a rise that interconnects the bottom and top landings. An improved truss design comprised of steel modules that are stamped or bent is used to form the rise, the top landing, and the bottom landing. The modules have closed sides, which increases the strength and stiffness of the truss while also providing the enclosure for internal escalator components. The modules are either formed as a single piece or formed from multiple pieces that are welded or fastened together. The modules are then secured to each other to form the rise, the top landing, and the bottom landing.

### BACKGROUND OF THE INVENTION

This invention relates to an improved support structure for an escalator that includes at least one stamping or pre-made module.

Escalators are typically supported on truss structures having a common, well-known design. The trusses are made from multiple segments of tubular steel that are cut to specified lengths with certain angles cut on each of the ends. Each of these segments is fixtured so that adjacent segments can be manually welded in place. This is time consuming and requires a highly skilled work force, which results in high costs for building each truss.

Once the truss is formed, brackets are attached to the truss to support tracks, exterior cladding, and other escalator hardware. Attachment of the brackets requires additional labor and usually requires shimming so that escalator components can be properly aligned when installed. Next the escalator components are installed at the factory and significant adjustments are made from outside of the truss to ensure that all components are properly and securely mounted. Finally, the exterior cladding is attached to cover the openings in the truss. The cladding adds cost and weight but does not provide any additional structural strength or stiffness.

Depending on location, each escalator installation has different design requirements that can vary the length and angle of rise for the escalator, the truss must be specifically cut and assembled for each different installation. Because the above described assembly process is so labor intensive, the costs for building the truss structure can be very high.

This invention provides an improved truss structure that provides a closed design that eliminates the need for exterior cladding while providing additional structural strength and stiffness. Further, the improved truss structure requires fewer components, is easy to assemble and install, and significantly reduces the number of brackets needed to attach other escalator hardware. The improved truss can also be assembled at the job site, which provides flexibility in shipping and allows truss components to be brought into existing building without difficulty.

### SUMMARY OF THE INVENTION

A support structure for an escalator includes a bottom landing support, a top landing support, and a rise that interconnects the bottom landing support to the top landing support. The rise includes at least one module.

In one disclosed embodiment, the module for the rise is formed as a single piece stamping extending from the bottom landing support to the top landing support. The stamping has a U-shape with a horizontal base portion and a pair of vertical side portions. At least one reinforcement beam is secured to each side portion of the stamping to provide sufficient strength and stiffness for the rise.

In another example, a portion of the truss length includes conventional diagonal support members. At each machine location, a module provides support. In one example, such modules comprise a steel sheet.

In another embodiment, the module is formed as a plurality of stamped modules with each module formed as a single piece stamping. Each stamping has a U-shape with a horizontal base portion and a pair of vertical side portions. Attachment plates are used to secure one stamped module to the next to form the rise. Beams are installed on each side portion and extend along the length the stamped modules to provide strength and stiffness.

In another embodiment, the module is formed as a plurality of stamped modules with each module formed from a plurality of stampings including a single bottom piece and a pair of side pieces welded to the bottom piece to form a U-shape. Attachment plates secure adjacent modules to each other. Beams are installed on each side portion and extend along the length the stamped modules to provide strength and stiffness.

In another embodiment, the module is formed as a plurality of stamped modules with each module being formed from a pair of stampings welded together. At least one channel beam is secured along one vertical edge of the module for joining with a mating channel beam on one of the adjacent stamped modules.

In another embodiment, the module is formed as a plurality of stamped modules with each module being formed from a first stamping having a generally vertical body portion with an angled upper edge and an angled lower edge and a second stamping having a generally vertical body potion with an angled upper edge and an angled lower edge. The first and second stampings being joined together such that the angled upper edges extend in opposing directions from each other to form an upper channel and the angled lower edges extending in opposing directions form each other to form a lower channel. Attachment plates join adjacent modules to each other. Beams are received in the upper and lower channels for reinforcing the rise.

By using formed modules, installation time is reduced, costs are decreased, and consistent high quality is provided. The modules also provide flexibility in producing support structures of varying length that can be rapidly assembled from a common inventory of parts.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 is an escalator supported on a truss structure known in the art.

FIG. 2 is a perspective view of one embodiment of the inventive truss structure.

FIG. 3 is a magnified perspective view of a portion of FIG. 2 using a fastener attachment method.

FIG. 4 is a view similar to FIG. 3 but showing a welding attachment.

FIG. 5 is an alternate embodiment of a truss structure.

FIG. 6 is an exploded view of the truss shown in FIG. 5.

FIG. 7 is an exploded view of an alternate embodiment of a truss structure.

FIG. 8 is a perspective view of an alternate embodiment of a truss structure.

FIG. 9 is a perspective view of an alternate embodiment of a truss structure.

FIG. 10 is an exploded view of an alternate embodiment of a truss structure.

FIG. 11 is another example of a truss designed according to this invention.

### DETAILED DESCRIPTION OF THE PREFERRED EMBODIMENT

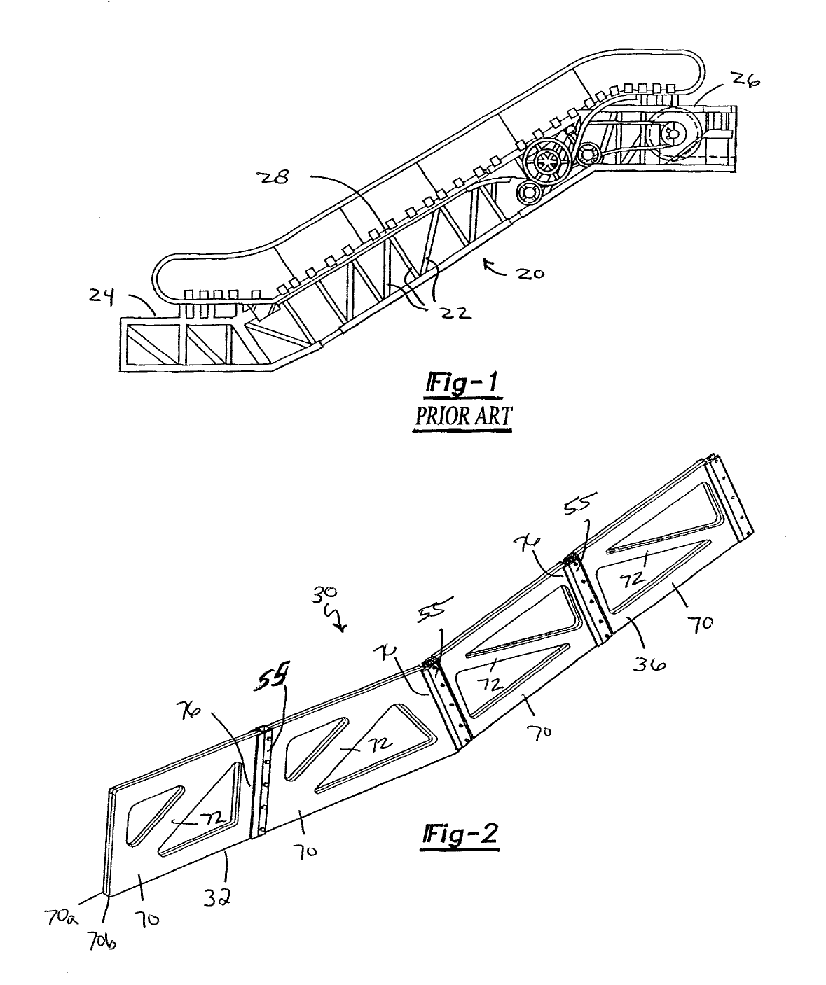

FIG. 1 illustrates an escalator supported on a known truss structure 20. The truss 20 is made from multiple segments 22 of tubular steel that are cut to specified lengths. Each of these segments 22 is manually welded to adjacent segments to form the truss 20. Typically, the truss 20 includes a bottom landing structure 24, a top landing structure 26, and a rise structure 28 that interconnects the bottom 24 and top 26 landing structures. Once the truss 20 is formed, brackets are attached to the truss to support tracks, exterior cladding, and other escalator hardware (not shown). Attachment of the brackets requires additional labor and usually requires shimming so that escalator components can be properly aligned when installed, which is time consuming and expensive.

A unique support structure assembly 30 for an escalator is shown in FIG. 2. The support structure includes a bottom landing support portion 32, a top landing support portion (not shown) similar to the bottom landing support portion 32, and a rise portion 36 that interconnects the bottom 32 and top landing supports. The rise portion 36 includes at least one module. The module is preferably made from steel and can be created using bending or stamping processes that are well known in the art.

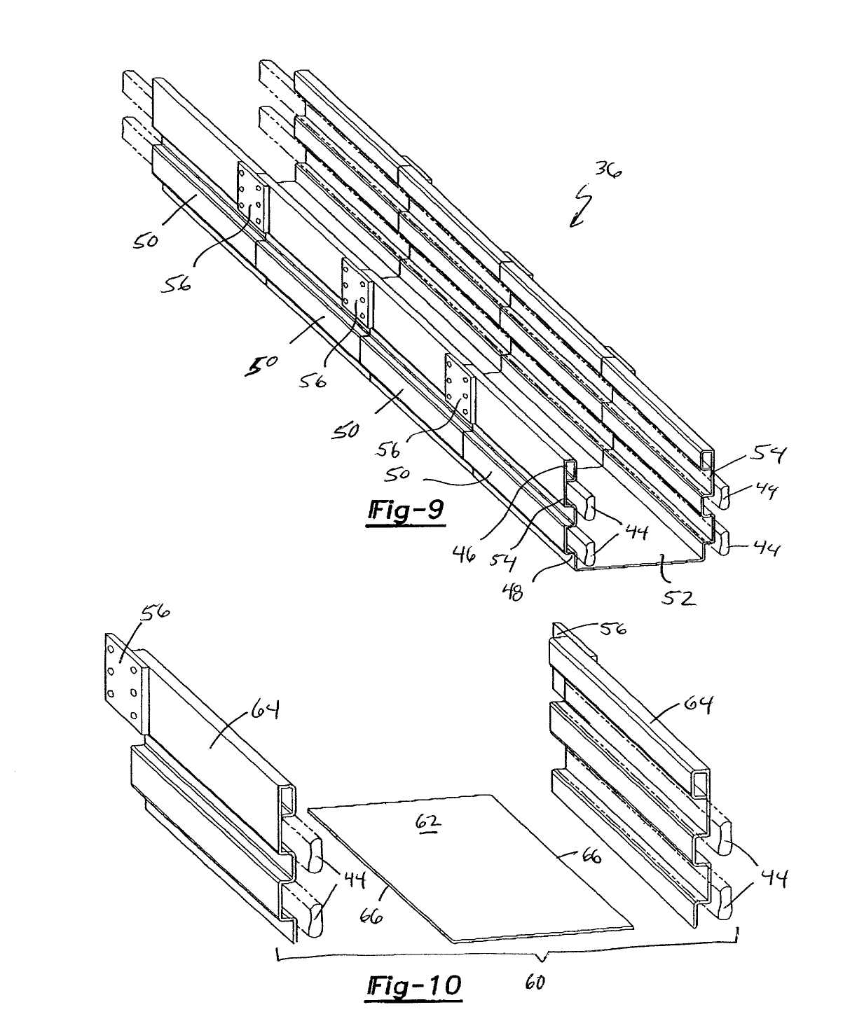

In one embodiment shown in FIG. 8, the module is formed as a single piece stamping 38 that extends from the bottom landing support 32 to the top landing support. The single piece stamping 38 is formed with a U-shape including a horizontal base portion 40 and a pair of vertical side portions 42.

Reinforcement beams 44 are secured to each side portion 42 of the stamping 38. In the preferred embodiment, the reinforcement beams are four inches by four inches with a quarter of an inch wall thickness. The reinforcement beams 44 provide additional rigidity and structural support for the escalator. Preferably a pair of beams is installed in each side portion 42 with one beam at the upper edge 46 and one beam at the lower edge 48 as shown in FIG. 9, however, a single beam 44 or more than two (2) beams 44 could be installed at each side 42. The bottom 32 and top 34 landing supports can be formed from similar stamped structures or traditional welded steel tubing trusses can be used.

In another embodiment, shown in FIG. 9, the steel module for the rise 36 is formed as a plurality of stamped modules 50. Each module 50 is formed as a single piece stamping having a U-shape with a horizontal base portion 52 and a pair of vertical side portions 54. A plurality of attachment plates 56 are used to secure one stamped module 50 to the next stamped module 50 to form the rise 36. The attachment plates 56 can be fastened, welded, or joined to the modules 50 by methods well known in the art. Any number of modules 50 can be used to form the rise 36 depending on the length and angle of orientation for the rise. Preferably, the rise 36 is formed from four (4) modules 50 that are secured to each other with the attachment plates 56. Beams 44 for reinforcing each side portion 54 are mounted to extend along the length of each stamped module. The bottom 32 and top 34 landing supports can be formed from similar stamped structures or traditional welded steel tubing trusses can be used.

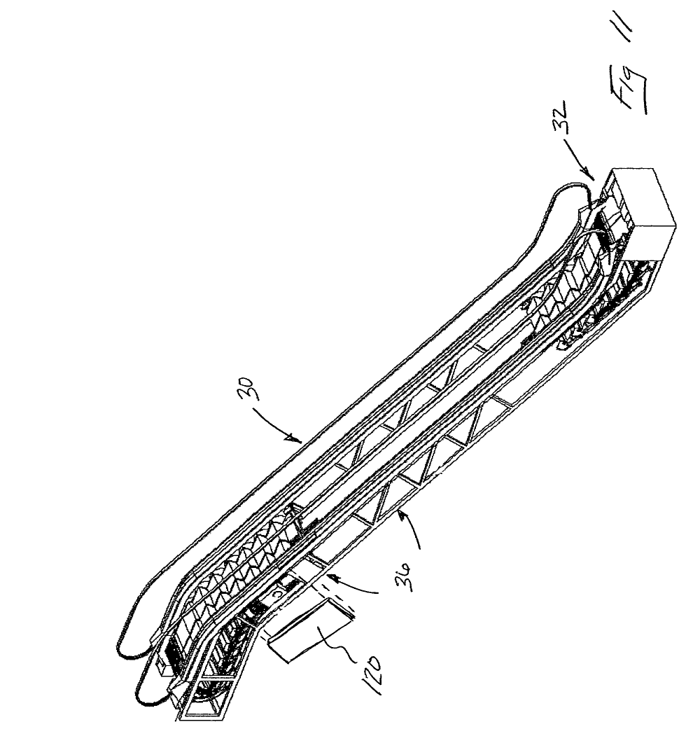

In an alternate embodiment, shown in FIG. 10, the module is formed as a plurality of stamped modules 60. Each module 60 is formed from a plurality of stamped pieces including a single bottom piece 62 and a pair of side pieces 64 welded perpendicularly to and along edges 66 of the bottom piece 62 to form a U-shape. Attachment plates 56 are used to secure one stamped module 60 to the next stamped module 60 to form the rise 36. Beams 44 for reinforcing the modules 60 are mounted to extend along the length the rise 36. The bottom 32 and top 34 landing supports can be formed from similar stamped structures or traditional welded steel tubing trusses can be used.

Another example is shown in FIG. 11. In this embodiment, portions of the structure near machine components include modules as support members. The illustrated example has a steel sheet 120 that preferably is welded in place. The module sheet 120 replaces tubular members adjacent to the drive machine.

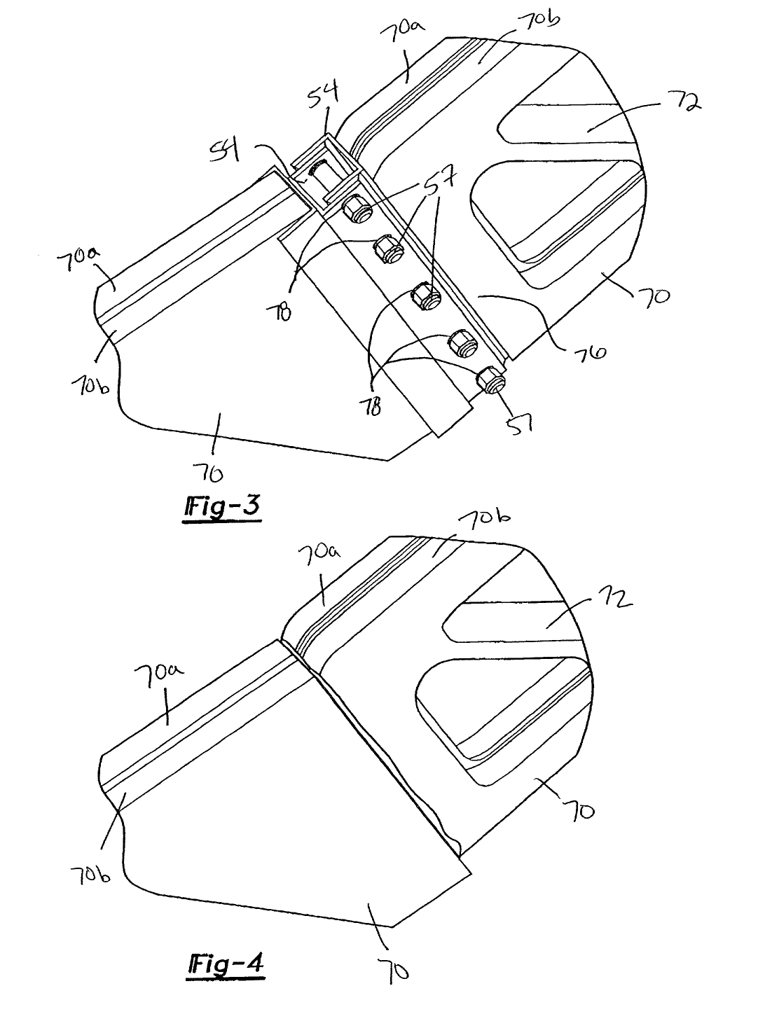

In an alternate embodiment, shown in FIG. 2, the steel module is formed as a plurality of stamped modules 70 with each module 70 formed from a pair of stampings 70a, 70b welded together about the circumference. The stampings 70a, 70b, include diagonal reinforcement portions 72 that are integrally formed within the stampings 70a, 70b as one piece. Channel beams 55 are secured along opposing vertical edges 76 of each of the modules 70. The channel beams 55 are preferably C-shaped, however, other beam configurations could also be used. The channel beam 55 from one module 70 is joined to a mating channel beam 55 on an adjacent stamped modules 70. The channel beams 55 can include a plurality of openings 78 for receiving fasteners 57 shown in FIG. 3, or the beams 55 can be welded together as shown in FIG. 4. Preferably, the bottom 32 and top 34 landing supports are also formed from similar stamped modules 70.

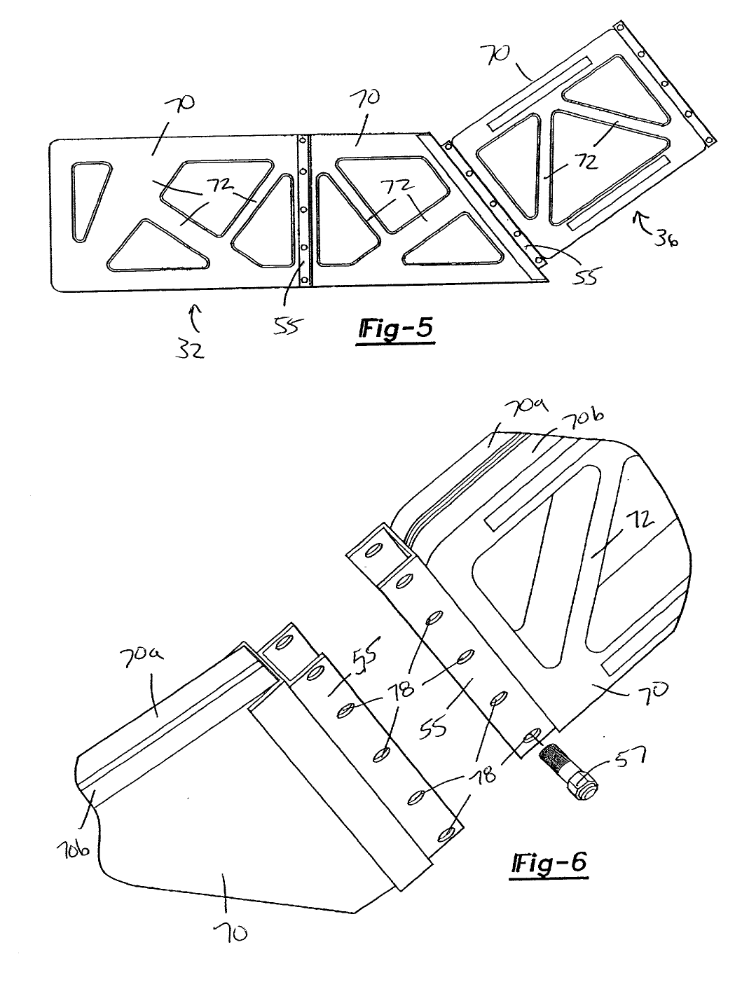

Another embodiment, shown in FIGS. 5 and 6, is similar to the embodiment of FIGS. 2-4. The steel module is formed as a plurality of stamped modules 70 with each module formed from a pair of stampings 70a, 70b, as discussed above. In this embodiment, multiple reinforcement portions 72 are integrally formed within the module 70.

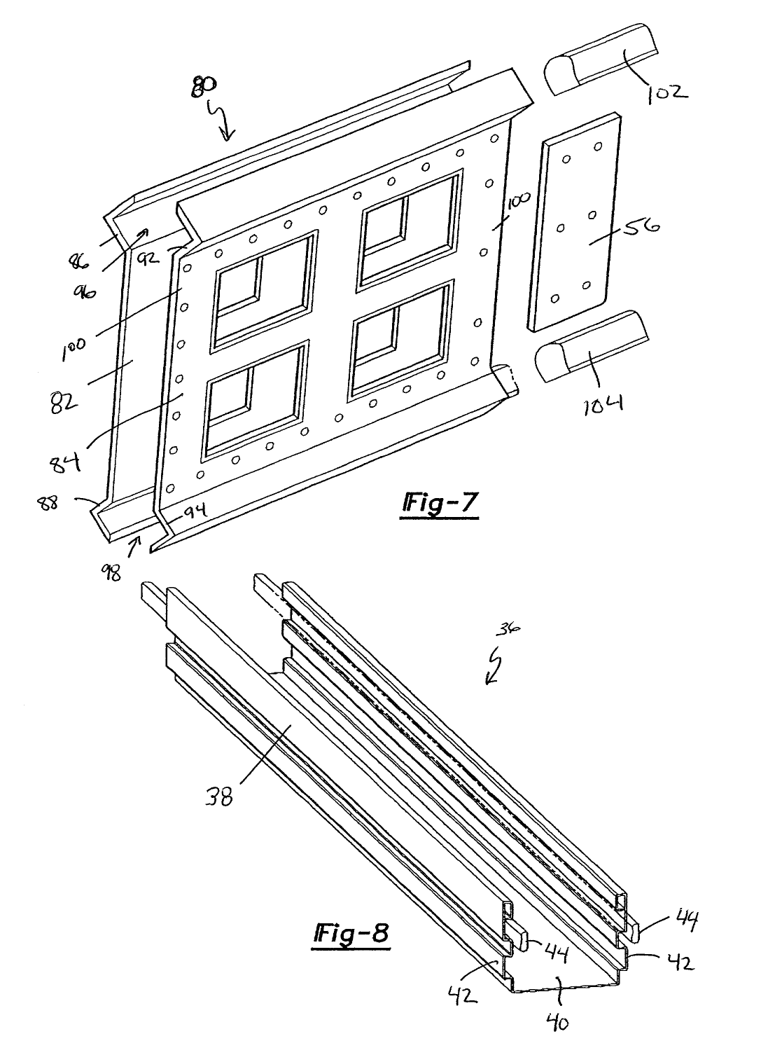

In another alternate embodiment shown in FIG. 7, the steel module is formed as a plurality of stamped modules 80 with each module 80 formed from a pair of stampings 82, 84. The first stamping 82 has a generally vertical body portion with an angled upper edge 86 and an angled lower edge 88. The second stamping 84 also has a generally vertical body potion with an angled upper edge 92 and an angled lower edge 94. The pair of stampings 82, 84 are mirror images of one another and are joined together such that the angled upper edges 86, 92 extend in opposing directions from each other to form an upper channel 96. The angled lower edges 88,94 also extend in opposing directions from each other to form a lower channel 98. Attachment plates 56 are used to join side edges 100 of the body portions to adjacent stamped modules 80 in a manner similar to that discussed above. Preferably, the bottom 32 and top 34 landing supports are also formed from similar stamped modules 80.

In the preferred embodiment, the angled upper 86, 92 and lower 88, 94 edges are at a forty-five degree angle with respect to the vertical body portions so that the channels 96, 98 are formed as a right angle, i.e. a ninety degree angle, when the first stamping 82 is joined to the second stamping 84. A first beam 102 is received in the upper channel 96 and a second beam 104 is received in the lower channel 98 for reinforcing the rise 36. Steel stamping manufacturing processes are well known in the art. Any type of steel stamping process can be used to form the stamped modules that are used for the escalator support structure. The steel stamping modules allow for easy assembly and installation of an escalator in older buildings that are being renovated. The modules also reduce the number of brackets and attachment hardware while providing the required structural strength and stiffness.

The foregoing description is exemplary rather than limiting in nature. Many modifications and variations of the present invention are possible in light of the above teachings. The preferred embodiments of this invention have been disclosed, however, one of ordinary skill in the art may recognize that certain modifications are possible that would come within the scope of this invention. It is, therefore, to be understood that within the scope of the appended claims, the invention may be practiced otherwise than as specifically described. For that reason the following claims should be studied to determine the true scope of protection given for this invention.

The following is claimed:

1. A support structure assembly for an escalator comprising:
a bottom landing support;
a top landing support; and
a rise for interconnecting said bottom landing support to said top landing support wherein said rise includes at least one module.

2. An assembly as recited in claim 1, wherein said at least one module is formed as a single piece stamping extending from said bottom landing support to said top landing support and having a U-shape with a horizontal base portion and a pair of vertical side portions.

3. An assembly as recited in claim 2, including at least one reinforcement beam secured to each side portion of said module.

4. An assembly as recited in claim 1 wherein said at least one module is comprises a plurality of stamped modules, each module formed as a single piece stamping having a U-shape with a horizontal base portion and a pair of vertical side portions and including a plurality of attachment plates for securing one stamped module to the next to form said rise.

5. An assembly as recited in claim 4, including a pair of beams for reinforcing each side portion and extending along the length of each stamped module.

6. An assembly as recited in claim 1, wherein said at least one module is formed as a plurality of stamped modules, each module formed from a plurality of stampings including a single bottom piece and a pair of side pieces welded to said bottom piece to form a U-shape; and including a plurality of attachment plates for securing one of said modules to the next of said modules.

7. An assembly as recited in claim 6, including a pair of beams for reinforcing each side portion and extending along the length of each stamped module.

8. An assembly as recited in claim 1, wherein said at least one module is formed as a plurality of stamped modules with each module formed from a pair of stampings welded together and including at least one channel beam secured along one vertical edge of said module for joining with a mating channel beam on one of said adjacent stamped modules.

9. An assembly as recited in claim 1, wherein said at least one module is formed as a plurality of stamped modules with each module formed from a first stamping having a generally vertical body portion with an angled upper edge and an angled lower edge and a second stamping having a generally vertical body potion with an angled upper edge and an angled lower edge, said first and second stampings being joined together such that said angled upper edges extend in opposing directions from each other to form an upper channel and said angled lower edges extending in opposing directions from each other to form a lower channel.

10. An assembly as recited in claim 9, including a plurality of attachment plates for joining side edges of said body portions of one of said stamped modules to the next of said stamped modules.

11. An assembly as recited in claim 10, including a first beam received in said upper channel and a second beam received in said lower channel for reinforcing said rise.

12. An assembly as recited in claim 11 wherein said angled upper and lower edges extend at a forty-five degree angle relative to said body portion such that said upper and lower channels are form as a ninety degree angle when said first stamping is joined to said second stamping.

13. The assembly of claim 1, wherein the module comprises a steel sheet near an escalator machine.

14. The assembly of claim 13, wherein the steel sheet module is welded to other portions of the rise.

15. A support structure assembly for an escalator comprising:
a bottom landing module;
a top landing module; and
a rise module for interconnecting said bottom and top landing modules wherein each of said modules is comprised of a plurality of sub-modules each made from a pair of steel forms joined together.

16. An assembly as recited in claim 15, including at least one channel beam secured along one vertical side edge of said sub-module for joining with a mating channel beam on an adjacent sub-module.

17. An assembly as recited in claim 16, wherein adjacent channel beams are fastened together with a plurality of fasteners.

18. An assembly as recited in claim 16 wherein adjacent channel beams are welded together.
